(19) United States
(12) Patent Application Publication
(10) Pub. No.: US 2015/0115833 A1
(43) Pub. Date: Apr. 30, 2015

(54) CONTROL OF LIGHT HAVING MULTIPLE LIGHT SOURCES

(71) Applicant: INDUSTRY-ACADEMIC COOPERATION FOUNDATION YEUNGNAM UNIVERSITY, Gyeongsangbuk-do (KR)

(72) Inventors: Jae Kyun Kwon, Dalseo-gu (KR); Kang-Il Ahn, Nam-gu (KR); Sung-Yoon Jung, Suseong-gu (KR); Ja-Soon Jang, Suseong-gu (KR)

(21) Appl. No.: 14/398,879

(22) PCT Filed: May 8, 2013
(86) PCT No.: PCT/KR2013/004046

§ 371 Date: Nov. 4, 2014

(30) Foreign Application Priority Data
May 8, 2012 (KR) 10-2012-0048645

(51) Int. Cl. H05B 33/08; H05B 37/02

(52) U.S. Cl. CPC H05B 33/08; H05B 37/02
USPC 315/294

(57) ABSTRACT

An illumination control method is disclosed. The illumination control method comprises the steps of: acquiring a list of control information items for satisfying light-emitting conditions for illumination generated by multiple light source elements in order to have a specific color and a specific light intensity; determining control information from the list so that the sum of each driving power source for the multiple light source elements is equal to or less than a predetermined value; and adjusting the driving power sources for the multiple light source elements on the basis of the determined control information, wherein the control information indicates the each driving power source for the plurality of light source elements, the light-emitting conditions include the light intensity for each of a plurality of wavelengths, and the number of light source elements is greater than the number of light-emitting conditions.

### TECHNICAL FIELD

The present invention relates to control of lighting and, more particularly, to control of lighting including a plurality of light sources.

### BACKGROUND ART

Active research is recently being carried out on lighting and display devices using Light Emitting Diodes (LED) and Organic Light Emitting Diodes (OLED). A light source needs to satisfy user needs in order to operate as lighting and a display device.

Such user needs include details, such as the intensity, color, and relative spectral emission of light.

### DISCLOSURE

### Technical Problem

In lighting and a display device that requires a variety of types of colors, in general, three types of light sources corresponding to three types of human's visual cells that classify colors of light are used to generate a variety of types of colors and light intensities depending on the intensities of light of elements.

An object of this specification is to provide a method of controlling a plurality of light sources so that consumption power is minimized or visual light communication (VLC) is performed while satisfying the requirements of a color and light intensity using the degree of freedom occurring when an additional light source is used in addition to a minimum number of light sources capable of implementing a variety of types of colors.

Furthermore, an object of this specification is to provide a method of controlling a plurality of light sources, which generates required lighting using a plurality of light sources if the lighting having a specific intensity is required depending on a wavelength.

Furthermore, an object of this specification is to provide a method of controlling a plurality of light sources, which is capable of satisfying the requirements of a color and light intensity and has an efficient communication capacity and consumption power using the degree of occurring freedom, when a plurality of light sources is used in visual light communication.

### Technical Solution

In an embodiment, there is disclosed a lighting control method in which driving power is taken into consideration. The lighting control method may include steps of obtaining a list of pieces of control information that satisfy a light-emitting condition in which lighting formed by a plurality of light source elements has a specific color or specific light intensity; determining control information that belongs to the list and that enables the sum of pieces of driving power of the plurality of light source elements to be a specific value or less; and controlling each of the pieces of driving power of the plurality of light source elements based on the determined control information.

The one embodiment may include any one of the following characteristics.

The control information may be indicative of the driving power of each of the plurality of light source elements. Furthermore, the light-emitting condition may include the light intensity of each of a plurality of wavelengths. Furthermore, the number of the light source elements may be greater than the number of the light-emitting conditions.

Furthermore, in the step of obtaining the list of pieces of control information, whether the light-emitting condition is satisfied may include determining whether the control information is control information by which the lighting complies with the light-emitting condition or whether the control information is control information by which the lighting is approximate within a permissible range of the light-emitting condition. Furthermore, the step of determining the control information may include determining the control information that belongs to the list and by which the sum of the pieces of driving power of the plurality of light source elements is a minimum.

Furthermore, the light-emitting condition may be the light intensity of each of wavelengths corresponding to respective R, G, and B, and the number of light source elements may be 4 or more.

Meanwhile, in another embodiment, there is disclosed a lighting control method for performing communication while always satisfying a light-emitting condition. The lighting control method includes steps of obtaining a list of pieces of control information that satisfy a light-emitting condition in which lighting formed by a plurality of light source elements has a specific color or specific light intensity; performing symbol mapping for data modulation on a signal constellation including control information selected from the list; and controlling each of the pieces of driving power of the plurality of light source elements based on data modulated according to the symbol mapping.

Another embodiment may include at any one of the following characteristics.

The control information may be indicative of the driving power of each of the plurality of light source elements. Furthermore, the light-emitting condition may include the light intensity of each of a plurality of wavelengths. Furthermore, the number of the light source elements may be greater than the number of the light-emitting conditions. Furthermore, the signal constellation may be formed based on a plurality of pieces of the control information that satisfy the light-emitting condition and that are present due to a difference between the number of light source elements and the number of light-emitting conditions.

Furthermore, the light-emitting condition may be the light intensity of each of wavelengths corresponding to respective R, G, and B, and the number of light source elements may be 4 or more.

Meanwhile, in yet another embodiment, there is disclosed a lighting control method for displaying a specific color or light intensity. The lighting control method may include steps of obtaining, by a lighting apparatus configured to include a plurality of light source elements, a list of pieces of control information, wherein the control information is indicative of driving power of each of the plurality of light source elements; determining control information that belongs to the list and that is most approximate to a light-emitting condition in which lighting generated by the lighting apparatus has a specific color or specific light intensity; and controlling the driving power of each of the plurality of light source elements based on the determined control information.

Yet another embodiment may include any one of the following characteristics.

The step of determining the control information may include determining control information by which a difference between the prediction value of a color and light intensity according to control information of the list and the light-emitting condition is a minimum.

Meanwhile, in further yet another embodiment, there is disclosed a lighting control method for performing communication while satisfying a light-emitting condition on average. The lighting control method is a method of controlling lighting so that a lighting apparatus configured to include a plurality of light source elements performs visual light communication and may includes steps of obtaining a light-emitting condition indicative of a specific color and light intensity of lighting; performing symbol mapping for data modulation so that a probability weighted average of symbols may be placed in a subspace on a signal space satisfying the light-emitting condition; and controlling driving power of each of the plurality of light source elements based on data modulated according to the symbol mapping.

Further yet another embodiment may include any one of the following characteristics.

The symbol mapping may be performed by taking into consideration data transfer efficiency, power efficiency, or lighting setting according to a specific light-emitting condition. Furthermore, in the step of performing the symbol mapping, the locations and probability of the symbols may be controlled based on the probability weighted average of the symbols on the signal space or the amount of mutual information.

Meanwhile, in still yet another embodiment, there is disclosed a lighting apparatus. The lighting apparatus may include a light-emitting unit which generates a visible ray signal using a plurality of light source elements generating light intensities of different wavelengths; a control unit which obtains a list of pieces of control information satisfying a light-emitting condition of lighting and determines specific control information that belongs to the list and by which the sum of pieces of driving power of the plurality of light source elements may be a specific value or less; and a driving unit which controls the driving power of each of the light source elements based on the specific control information.

The control unit may code data based on a symbol table having a range that satisfies the light-emitting condition on average, and the driving unit may control the driving power so that the visible ray signal may be generated based on the coded data.

### Advantageous Effects

In accordance with the invention disclosed in this specification, if a plurality of light sources elements is used, consumption power can be reduced, and light-emitting conditions, such as colors and light intensities that need to be generated by lighting or a display device, can be satisfied.

Furthermore, in accordance with the invention disclosed in this specification, lighting or a display device generates lighting that satisfies light-emitting conditions using the plurality of light source elements and also satisfies the light-emitting conditions every moment. Accordingly, visual light communication can be performed even using a low-speed pulse to the extent that the low-speed pulse can be recognized by the human eye having a pulse frequency in which, in general, visual light communication is not performed.

Furthermore, in accordance with the invention disclosed in this specification, there is an advantage in that lighting control approximate to requirements when an intensity distribution for a specific wavelength is required for lighting to which a plurality of light sources has been applied.

Furthermore, in accordance with the invention disclosed in this specification, there are advantages in that lighting and a display device have the same performance and efficiency of consumption power and a communication capacity can be maximized because the degree of freedom occurring when a plurality of light sources is used in visual light communication.

### DESCRIPTION OF DRAWINGS

FIG. 1 illustrates a lighting system including a plurality of light source elements in which a technology disclosed in this specification may be adopted.

FIG. 2 is a flowchart regarding control of lighting by which a light-emitting condition of the lighting is satisfied and consumption power is reduced.

FIG. 3 is a flowchart regarding control of lighting by which a light-emitting condition of the lighting is satisfied every moment and visual light communication is performed.

FIG. 4 is a flowchart regarding a method of generating lighting approximate to a specific condition.

FIG. 5 is a flowchart regarding control of lighting in which visual light communication is performed.

FIG. 6 illustrates an example of symbol mapping for color-intensity modulation in a 2-dimensional orthogonal signal space.

### MODE FOR INVENTION

A technology disclosed in this specification is applied to lighting and a display. However, the technology disclosed in this specification is not limited to the lighting and the display and may also be applied to all the lighting methods and apparatuses and all the display methods and apparatuses to which the technical spirit of the technology may be applied.

Furthermore, in describing the present invention, a detailed description of the known functions and constructions will be omitted if it is deemed to make the gist of the present invention unnecessarily vague. It is also to be noted that the accompanying drawings are provided to only help easily understand the spirit of the present invention and the spirit of the present invention is limited by the accompanying drawings. The spirit of the present invention should be construed as being extended up to all changes, equivalents, and substitutes in addition to the accompanying drawings.

Furthermore, an expression of the singular number used in this specification includes an expression of the plural number unless clearly defined otherwise in the context. In this application, terms, such as “comprise” and “include”, should not be construed as essentially including all several elements or several steps described in the specification, but the terms may be construed as not including some of the elements or steps or as including additional elements or steps.

Furthermore, it is to be noted that the suffixes of elements used in this specification, such as a “module” and a “unit,” are assigned or interchangeable with each other by taking into consideration only the easiness of writing this specification, but themselves are not given particular importance and roles.

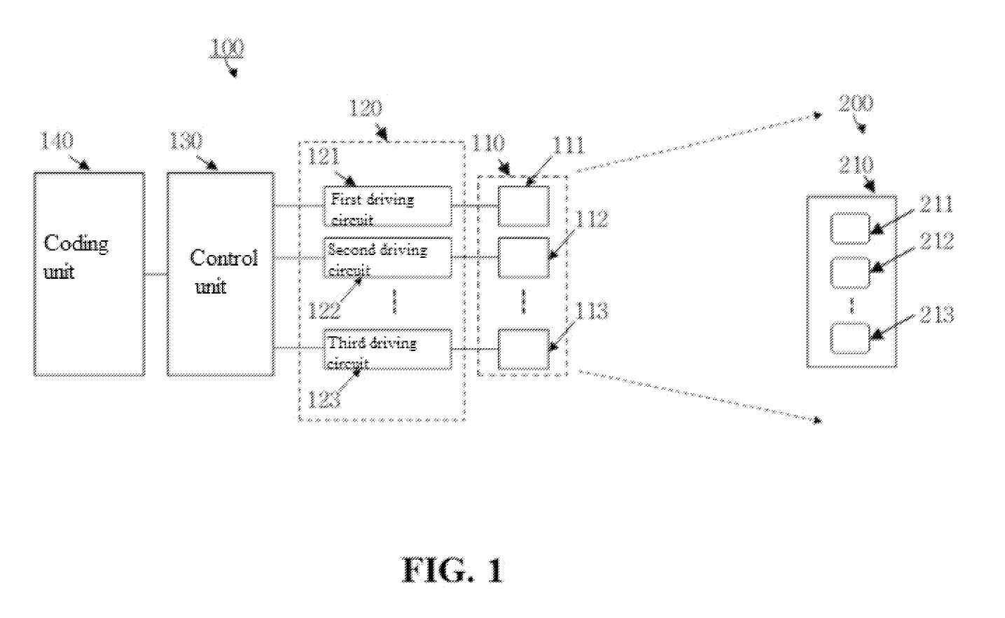

Furthermore, terms including ordinal numbers, such as the first and the second, may be used to describe various constituent elements, but the constituent elements are not limited by the terms. The terms are used to only distinguish one constituent element from the constituent other element. For example, a first element may be named a second element without departing from the scope of the present invention. Likewise, a second element may be named a first element. A lighting system is disclosed with reference to FIG. 1. FIG. 1 illustrates a lighting system including a plurality of light source elements in which a technology disclosed in this specification may be adopted.

The lighting system includes a light-emitting apparatus 100 and a light-receiving apparatus 200. The light-emitting apparatus 100 is an apparatus for generating a visible ray and may be implemented in a form, such as a lighting apparatus, display device, or visual light communication (VLC) transmitter, for example. The light-receiving apparatus 200 is an apparatus for receiving a visible ray and may be implemented in a form, such as a visual light communication receiver, for example.

The light-emitting apparatus 100 is configured to include a light-emitting unit 110 for generating a visible ray signal. The light-receiving apparatus 200 is configured to include a light-receiving unit 210 for receiving lighting, including data, from the light-emitting unit 110 in a visual light communication way.

The light-emitting unit 110 generates a visible ray signal using a plurality of light source elements 111, 112, and 113 that generate colors of different wavelengths.

The light-emitting unit 110 may be implemented to include a plurality of light source elements. The light source elements 111, 112, and 113 may be Light Emitting Diodes (LED) or Organic Light Emitting Diodes (OLED). FIG. 1 illustrates the three light source elements 111, 112, and 113, but the number of light source elements that form the light-emitting unit 110 is not limited thereto.

The light source elements 111, 112, and 113 may be light source elements having different wavelength characteristics. Accordingly, the light-emitting apparatus 100 needs to drive the light source elements 111, 112, and 113 so that pieces of light of different wavelengths generated by the respective light source elements 111, 112, and 113 are summed to generate a specific color and light intensity required to function as lighting.

A driving unit 120 for supplying a power source is connected to the light source elements 111, 112, and 113. The driving unit 120 is configured to include first, second, and third driving circuits 121, 122, and 123 that are connected to the respective light source elements 111, 112, and 113 and that supply power sources for the respective light source elements.

Lighting generated by the light source elements of the light-emitting unit 110 needs to satisfy a light-emitting condition. A light-emitting condition of lighting used in this specification refers to a specific color, a specific light intensity or a combination of them that is required for the lighting. A control unit 130 may control the power sources supplied to the respective light source elements by controlling the driving unit 120 in order to satisfy a light-emitting condition of lighting.

More specifically, the control unit 130 may control the light-emitting unit 110 while satisfying the light-emitting condition required for lighting so that the light-emitting apparatus 100 operates as the lighting. To this end, the control unit 130 may obtain pieces of control information that satisfy the light-emitting condition and control the light-emitting unit 110. The pieces of control information are information about an electric current or electric power of the light source elements.

A method of controlling, by the light-emitting apparatus 100, lighting depending on a light-emitting condition of lighting is described below.

Assuming that the number of light source elements is m and the amount of light per unit power that is generated by a j^{th} light source element of the light source elements is Tᵢ (λ), lighting T(λ) generated by the light-emitting unit 110 may be expressed as in Equation 1 below.

T(λ) [symbol] αᵢTᵢ(λ) [Equation 1]

In Equation 1, αᵢ means power supplied to the j^{th} light source element and satisfies 0≦αᵢ≦P_{max.i}. λ is a wavelength.

The lighting T(λ) generated by the light-emitting unit 110 needs to satisfy the light-emitting condition. That is, the lighting of the light-emitting unit 110 needs to satisfy a light-emitting condition of a specific color or the light intensity that is required at a disposed place. The lighting T(λ) generated by the light-emitting unit 110 needs to satisfy a specific light-emitting condition independently of characteristics applied to the light source elements 111, 112, and 113. This may be expressed as in Equation 2.

∫T(λ)Cᵢ(λ)dλ=cᵢ [Equation 2]

In Equation 2, Cᵢ (λ) is a j^{th} condition function, and cᵢ is a condition value and may be obtained as a result of the scalar product of the j^{th} condition function Cᵢ (λ) and the lighting T(λ) generated by the light-emitting unit 110.

Accordingly, the control unit 130 controls the power sources applied to the respective light source elements in order to satisfy the condition value cⱼ as a light-emitting condition of lighting.

For example, if lighting generated by the light-emitting unit 110 is required to have a color of light directly seen to the human eye, the sensitivities of the wavelengths of three visual cells related to color distinction become condition functions [C₁(λ), C₂ (λ), C₃ (λ)] and required colors become condition values c₁, c₂, c₃. For example, the condition values c₁, c₂, and c₃ may be condition values indicative of respective RGB colors.

Accordingly, a lighting control method disclosed in this specification relates to control of the driving power of the light-emitting apparatus in order to satisfy the light-emitting condition value of lighting.

In some embodiments, the control unit 130 may control the driving circuits of the light-emitting apparatus by taking power consumption into consideration based on a list of pieces of control information that satisfy a light-emitting condition value of lighting. To this end, the control unit 130 may obtain a list of pieces of control information that satisfy the light-emitting condition of the lighting and determine control information capable of minimizing power consumption. That is, the control unit may determine specific control information that belongs to the list and by which the sum of pieces of driving power of the plurality of light source elements is a specific value or less.

In other embodiments, the control unit 130 may control the driving circuits of the light-emitting apparatus so that the light-emitting condition value of lighting is satisfied and visual light communication is performed. In this case, the light-emitting condition of the lighting is not satisfied on average with respect to a sufficient short time as in known visual light communication, but is always satisfied. In general, in known visual light communication, a light-emitting condition of lighting is satisfied only at a specific moment. In this technology, a light-emitting condition of lighting can be satisfied every moment, and visual light communication of a low-speed pulse that is difficult to be driven in known visual light communication can be performed. The control unit 130 may perform symbol mapping for data modulation so that visual light communication is performed in pieces of control information that satisfy the light-emitting condition.

In other embodiments, the control unit 130 may control the driving circuits of the light-emitting apparatus so that lighting most approximate to the light-emitting condition value of the lighting is generated.

In other embodiments, the control unit 130 may control the driving circuits of the light-emitting apparatus so that a light-emitting condition value of lighting is satisfied on average for a short time during which the light-emitting condition value is not recognized by the human eye and visual light communication is performed. The control unit 130 may code source data so that the light-emitting condition is satisfied and data can be transmitted. The driving unit 120 may control each of the pieces of driving power based on the coded data so that a visible ray signal is generated.

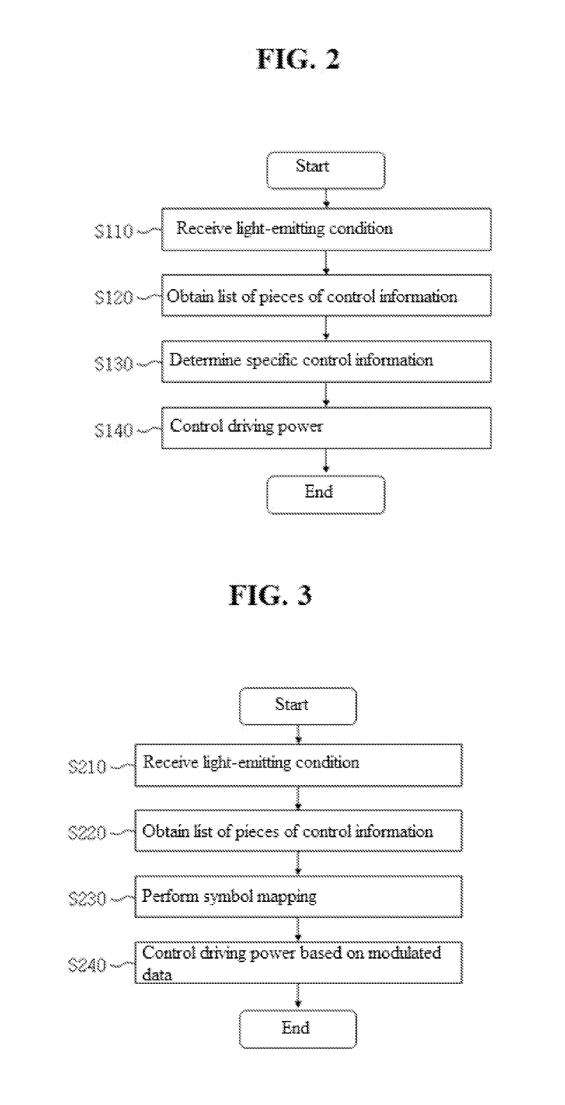

A method of reducing consumption power while satisfying a light-emitting condition of lighting in accordance with a first embodiment of the technology disclosed in this specification is described below with reference to FIG. 2. FIG. 2 is a flowchart regarding control of lighting by which a light-emitting condition of lighting is satisfied and consumption power is reduced.

In the first embodiment of the technology disclosed in this specification, if the number of light-emitting conditions of lighting is smaller than the number of light-emitting elements, a combination of pieces of electric power of the light-emitting elements is not determined to be 1, but is determined to be various in order to satisfy the light-emitting conditions, and a power combination whose total consumption power is small is selected from the power combinations.

More specifically, assuming that the number of light-emitting conditions of the lighting is k and the number of light-emitting elements is m, there may be a plurality of combinations α₁, . . . , αₘ of the pieces of electric power of the respective light-emitting elements that satisfy condition values c₁, . . . , cₖ with respect to a light-emitting apparatus having k<m. Accordingly, the light-emitting apparatus 100 lists pieces of control information corresponding to combinations of the pieces of electric power of the light-emitting elements that satisfy the light-emitting condition and selects a required combination from the listed combinations.

That is, the light-emitting apparatus 100 selects a combination α₁*, . . . , αₘ* of the pieces of electric power of the light-emitting elements which satisfies the light-emitting condition, such as Equation 3, and at which consumption power is a specific reference value or less. Specially, although k is smaller than or equal to m, the light-emitting condition may not be satisfied even though the light-emitting elements are combined. In such a case, likewise, the most approximate combination is selected.

$$P {=}^{Δ} {\sum }_{j = 1}^{m} {α}_{j} \qquad [ Equation 3 ]$$

Thereafter, the light-emitting apparatus 100 controls the supply of power to the light-emitting elements based on the selected combination α₁*, . . . , αₘ*.

First, the light-emitting apparatus 100 receives a light-emitting condition of lighting (S110). The light-emitting condition may relate to a color or light intensity of the lighting generated by the plurality of light source elements. That is, the light-emitting condition may relate to a color or light intensity of the lighting that is required for a person or the light-receiving apparatus 200 in a place where the light-emitting apparatus 100 is disposed. If the light-emitting condition relates to the color of the lighting, the number of light source elements may be greater than the number of light-emitting conditions in order to display the color of the lighting.

Meanwhile, the light-emitting condition may be a condition on each of the three RGB colors that may determine a color of lighting recognized on the side of the light-receiving apparatus 200, for example. In general, a color of a visible ray recognized by the human eye may be represented as a condition on each of the three RGB colors. In such a case, if the light-emitting condition is indicative of the light intensity of each of the RGB colors and the number of light source elements is 4 or more that is greater than the number of light-emitting conditions, an output combination of the light source elements that satisfies the light-emitting condition may be selected from various types. In this case, the light-emitting condition is not limited to only a combination of the three RGB colors disclosed as the example, but may be given as a condition on colors of other wavelengths.

The process S110 of receiving, by the light-emitting apparatus 100, the light-emitting condition of the lighting may be performed in various ways, such as a method of receiving, by the light-emitting apparatus 100, the light-emitting condition of the lighting through communication with the outside or a method of previously setting the light-emitting condition of the lighting when the light-emitting apparatus 100 is produced, disposed, or starts its operation.

Thereafter, the light-emitting apparatus 100 obtains a list of pieces of control information including pieces of driving power of the respective light source elements (S120). The control information may be a condition function for the light source elements. The control information may be represented as supply power to the light source elements.

The procedure of obtaining the list of pieces of control information includes a process of determining whether the light-emitting condition is satisfied based on a condition function that may be taken for the light-emitting elements. Alternatively, the list of pieces of control information may be obtained from a table in which the pieces of control information have been previously determined and stored. That is, the table in which the list of pieces of control information is stored may include the colors and light intensities of the plurality of light source elements corresponding to the light-emitting condition.

Thereafter, the light-emitting apparatus 100 determines specific control information that belongs to the list of pieces of control information and by which the sum of pieces of driving power of the plurality of light source elements becomes a specific value or less (S130). Thereafter, the light-emitting apparatus 100 controls each of the pieces of driving power of the light source elements based on the specific control information (S140).

A method of performing visual light communication while always satisfying a light-emitting condition of lighting in accordance with a second embodiment of the technology disclosed in this specification is described with reference to FIG. 3. FIG. 3 is a flowchart regarding control of lighting by which a light-emitting condition of the lighting is satisfied every moment and visual light communication is performed.

In known visual light communication, lighting having a frequency pulse of a specific value or more, for example, a minimum of 150 Hz or more is used so that flickering in the lighting is not sensed by the human eye when the lighting including data modulated in order to perform data communication is received. Accordingly, if the light-receiving elements 211, 212, and 213 forming the light-receiving unit 210 of the light-receiving apparatus 200 that performs visual light communication are photo diodes, a lighting pulse of 150 Hz or more may be received and visual light communication data may be decoded.

A known cheap image sensor, for example, a camera is unable to receive such high-speed communication data. The visual light communication method in accordance with the second embodiment of the technology disclosed in this specification relates to the transmission of data through modulation using the remaining transmission dimension while satisfying a light-emitting condition of lighting.

Accordingly, in the second embodiment of the technology disclosed in this specification, assuming that the number of light-emitting elements of the light-emitting apparatus is greater than the number of light-emitting conditions of lighting and a variety of types of combinations of pieces of electric power of the light-emitting elements that satisfy a light-emitting condition are present, visual light communication is performed through modulation that changes the selection of a power combination. Lighting including modulated data is identically recognized with a required color and intensity because a light-emitting condition is still satisfied although a power combination is changed by such modulation, but the light intensity T(λ) of each of the wavelengths of lighting is not identically maintained. Accordingly, visual light communication between the light-emitting apparatus 100 for generating lighting in accordance with the second embodiment and the light-receiving apparatus 200 for receiving the lighting is performed when the light-receiving apparatus 200 recognizes a difference between the light intensities of the respective wavelengths of the lighting and modulates data.

More specifically, with respect to a light-emitting apparatus in which k<m assuming that the number of light-emitting conditions of lighting is k and the number of light-emitting elements is m, there may be a plurality of combinations α₁, . . . , αₘ of pieces of electric power of the light-emitting elements that satisfy the condition values c₁, . . . , cₖ. Accordingly, the light-emitting apparatus 100 lists pieces of control information indicative of combinations of pieces of electric power of the respective light-emitting elements that satisfies the light-emitting condition and selects a combination that may be used for data modulation from the listed combination.

In general, the number of light-emitting conditions of the lighting is 3 for the RGB colors in the case of the human eye and may have a specific value in the case of other objects. For example, if the light-emitting condition of the lighting is indicated as the light intensity of three wavelengths corresponding to the RGB colors as in the human eye and the number of light-emitting elements m is greater than 3, a dimension that belongs to m dimensions and that is recognized by a person in sending the lighting is used to satisfy a specific color and light intensity, and the remaining dimensions that belong to the m dimensions may be used as a communication channel for data transmission. If the number of light source elements is 4, that is, m=4, a single dimension remains for visual light communication, and the light-emitting apparatus 100 may dispose a signal constellation on the straight line of the remaining single dimension, may modulate data through a symbol mapping process, and may send the modulated data.

In such a case, since the light-emitting condition of the lighting is always satisfied, flickering may not be sensed although communication using a low-speed pulse is performed if the light-emitting condition corresponds to the RGB colors with respect to the human eye.

First, the light-emitting apparatus 100 receives a light-emitting condition of lighting (S210). The light-emitting condition may relate to a color or light intensity of the lighting generated by the plurality of light source elements.

The light-emitting condition may be a condition on each of RGB colors that may determine the color of the lighting, for example. In such a case, if the light-emitting condition is indicative of the light intensity of the RGB colors and the number of light source elements is 4 or more that is greater than the number of light-emitting conditions, a light intensity of the RGB colors that satisfies the light-emitting condition may be selected from a variety of types. In this case, the light-emitting condition is not limited to the three RGB colors, and may include a condition of colors of other wavelengths and may have a specific number of conditions not limited to the RGB colors.

Thereafter, the light-emitting apparatus 100 obtains a list of pieces of control information that satisfy a specific light-emitting condition (S220). The specific light-emitting condition is a constraint in which lighting generated by the plurality of light source elements of the light-emitting apparatus 100 displays a specific color and light intensity.

The control information may be a condition function for the light source elements. The control information may be represented as supply power to the light source elements. A procedure for obtaining the list of pieces of control information includes a process of determining whether the light-emitting condition is satisfied based on a condition function that may be taken for the light-emitting elements. Alternatively, the list of pieces of control information may be obtained from a table in which the list of pieces of control information has been previously determined and stored. That is, the table in which the list of pieces of control information is stored may include the colors and light intensities of the plurality of light source elements corresponding to the light-emitting condition.

Thereafter, the light-emitting apparatus 100 forms a signal constellation to be used for data communication based on the list of pieces of control information and performs symbol mapping for data modulation on the signal constellation (S230). The signal constellation is for using a plurality of pieces of control information attributable to a difference between the number of light source elements and the number of light-emitting conditions in the symbol mapping with respect to the pieces of control information of the list that satisfy the specific light-emitting condition.

Thereafter, the light-emitting apparatus 100 controls the driving power of each of the plurality of light source elements based on data modulated according to the symbol mapping (S240). In such a case, since lighting generated by the light-emitting apparatus 100 always satisfies the specific light-emitting condition, communication in which flickering is not felt irrespective of whether the lighting operates with a low-speed pulse is made possible.

In a specific embodiment, the light-receiving apparatus for visual light communication according to the second embodiment may be configured so that the number of light-receiving elements is greater than the number of light-emitting condition in order to improve communication performance. For example, if a light-emitting condition is for the human eye, it is advantageous to improve communication performance when the number of light-emitting elements is 4 or more and the number of light-receiving elements is also 4 or more because the number of light-emitting conditions is 3. In this case, even though the number of light-receiving elements is 3 or less, if the responsivity or sensitivity of each of the wavelengths of the light-receiving elements is different from the sensitivity of each of the wavelengths of the RGB colors of the human eye, communication can be performed based on a difference between the sensitivities although the human eye feels the same color and intensity.

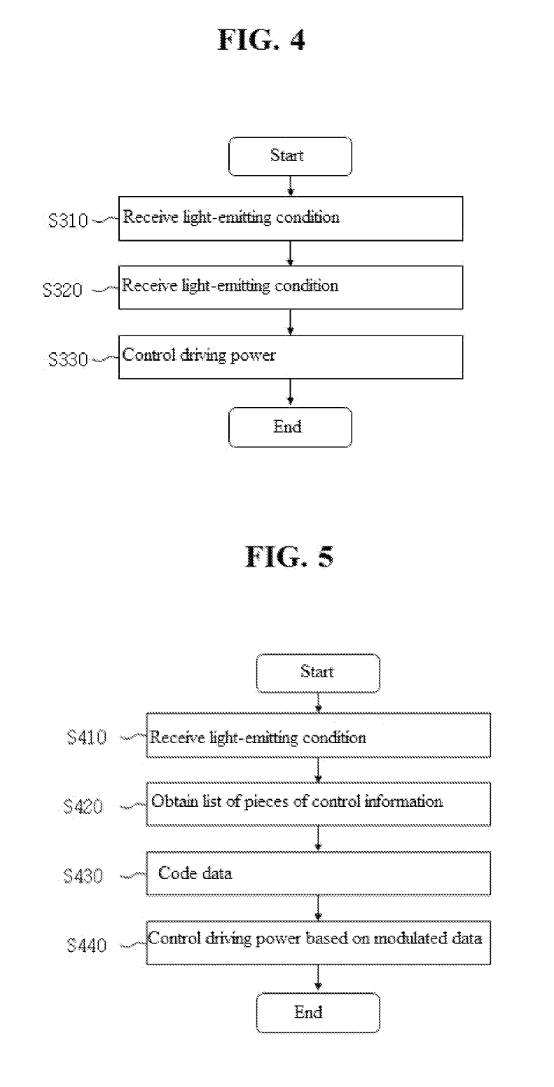

A method of generating lighting approximate to a light-emitting condition of the lighting in accordance with a third embodiment of the technology disclosed in this specification is described with reference to FIG. 4. FIG. 4 is a flowchart regarding a method of generating lighting approximate to a specific condition.

In the third embodiment of the technology disclosed in this specification, if the number of light-emitting conditions of lighting is greater than the number of light-emitting elements, a combination of pieces of electric power of the light-emitting elements that satisfies the light-emitting condition to the upmost degree is selected.

More specifically, with respect to a light-emitting apparatus in which k>m assuming that the number of light-emitting conditions of the lighting is k and the number of light-emitting elements is m, if the light-emitting condition is not satisfied by combining light source elements smaller than the number of light-emitting conditions, lighting most approximate to the light-emitting condition is generated. That is, if lighting having a specific intensity for each wavelength according to a light-emitting condition of lighting is required or if the number k of light-emitting conditions is greater than m, the combinations α₁, . . . , αₘ of the pieces of electric power of the light source elements that satisfy the light-emitting condition values c₁, . . . , cₖ may not be present. In such a case, the light-emitting apparatus 100 selects the combinations α₁, . . . , αₘ of the pieces of electric power of the light source elements that is most approximate to the condition values c₁, . . . , cₖ. In this case, a case where k>m is described, but a combination of the pieces of electric power of the light-emitting elements that satisfies a light-emitting condition may not be present even when k is m or less. In such a case, the same description is established.

First, the light-emitting apparatus 100 receives a light-emitting condition indicative of the color and light intensity of lighting (S310). The number of light-emitting condition may be greater than the number of light source elements. The light-emitting condition may relate to a color or light intensity of the lighting generated by the plurality of light source elements. If the light-emitting condition relates to the color of the lighting, the number of light source elements may be smaller than the number of light-emitting conditions.

The process S310 of receiving, by the light-emitting apparatus 100, the light-emitting condition of the lighting may be performed in various ways, such as a method of receiving, by the light-emitting apparatus 100, the light-emitting condition of the lighting through communication with the outside or a method of previously setting the light-emitting condition of the lighting when the light-emitting apparatus 100 is produced, disposed, or starts its operation.

Thereafter, the light-emitting apparatus 100 determines control information, including pieces of driving power of the plurality of light source elements that chiefly generate light of different wavelengths, based on the light-emitting condition of the lighting (S320). The control information is determined to have a value approximate to the light-emitting condition of the lighting. The value approximate to the light-emitting condition of the lighting is determines so that a target light-emitting condition value is most approximate to a calculated value of the light-emitting condition. A criterion for minimizing the sum of a square of a difference between the two values may be used.

More specifically, a method of selecting the control information most approximate to the light-emitting condition, that is, the combinations α₁, . . . , αₘ of the intensities of the light source elements, may be based on the least square method of minimizing the sum of a square of the difference [(c₁−c₁*)²+ . . . +(Cₖ−Cₖ*)²], for example, assuming that a scalar product formed by lighting T(λ) generated by the combinations α₁, . . . , αₘ of the intensities of the light source elements and a j^{th} condition function Cᵢ (λ) is cᵢ*.

In another method, the control information may be made approximate to the light-emitting condition so that a maximum value [maxᵢ|cᵢ−cᵢ*|] of the absolute value of the difference is minimized. In addition, several criteria for an approximation condition may be used.

Thereafter, the light-emitting apparatus 100 controls the driving power of each of the light source elements based on the control information (S330).

The light-emitting apparatus 100 according to the third embodiment may be implemented using a lighting apparatus that displays a specific color. In particular, the light-emitting apparatus 100 according to the third embodiment may be implemented to generate custom-tailored lighting by taking into consideration a function indicative of the degree of reflection of a specific reflector.

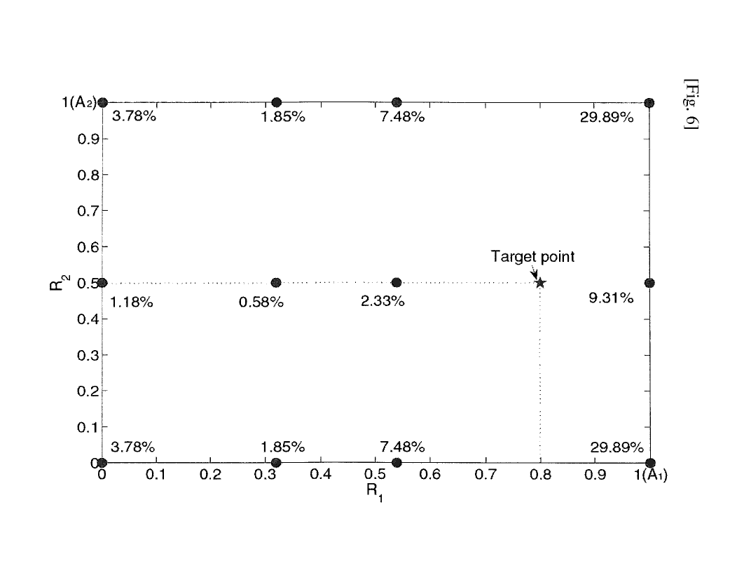

A method of performing visual light communication while satisfying a light-emitting condition of lighting in accordance with a fourth embodiment of the technology disclosed in this specification is described with reference to FIG. 5. FIG. 5 is a flowchart regarding control of lighting by which visual light communication is performed.

The fourth embodiment of the technology disclosed in this specification relates to the method of performing visual light communication through lighting by the light-emitting elements while satisfying the light-emitting condition.

In particular, as in the first embodiment and the second embodiment, in the fourth embodiment, if the number of light-emitting condition of lighting is smaller than the number of light-emitting elements, a power combination that belongs to various combinations of pieces of electric power of the light-emitting elements and that has better communication efficiency or low energy is selected in order to satisfy the light-emitting condition.

In this case, the aforementioned first embodiment and the second embodiment relate to a method of controlling lighting generated by the light-emitting apparatus so that the lighting always satisfies a light-emitting condition. In contrast, the fourth embodiment corresponds to a method of controlling lighting so that the lighting generated by an actual light-emitting apparatus satisfies the light-emitting condition on average for a short time during which the lighting is not recognized by the human eye because symbol mapping for coding is performed in a signal space in order to improve communication efficiency.

More specifically, assuming that the number of light-emitting conditions of the lighting is k and the number of light-emitting elements is m, if the number of light-emitting elements is greater than the number of light-emitting conditions (k<m) and the light-emitting apparatus 100 is used as lighting for performing visual light communication, the light-emitting condition of the lighting may be satisfied when a communication operation is performed so that the weighted average of a symbol is the same as the combination α₁, . . . , αₘ of the pieces of electric power of the light source elements that satisfies the condition value c₁, . . . , cₖ of the lighting. Accordingly, a restriction to the weighted average of the symbol is changed depending on the selection of the combination α₁, . . . , αₘ of the pieces of electric power of the light source elements, which means a change of communication performance. As in the fourth embodiment, if m>k, a combination α₁*, . . . , αₘ* of the pieces of electric power of the light source elements that maximizes visual light communication performance may be selected because the combination α₁, . . . , αₘ of the pieces of electric power of the light source elements can be selected. If m=k, a single combination of the pieces of electric power of the light source elements is selected other than special cases.

First, the light-emitting apparatus 100 receives a light-emitting condition of lighting (S410). The light-emitting condition may relate to a color or light intensity of the lighting generated by the plurality of light source elements. If the light-emitting condition relates to the color of the lighting, the number of light source elements may be greater than the number of light-emitting conditions.

Thereafter, the light-emitting apparatus 100 obtains a list of pieces of control information including pieces of driving power of the plurality of light source elements (S420). The control information may correspond to a symbol within a modulation space that is formed based on the light-emitting condition of the lighting. The modulation space may be for color-intensity modulation (CIM) for modulation within a range in which the light-emitting condition of the lighting is satisfied. In such a case, the modulation space may be a signal space. The signal space is for indicating lighting received by the light-receiving apparatus 200 in the form of a signal received by each of the light-receiving elements.

Thereafter, the light-emitting apparatus 100 codes the data based on the control information (S430). The coding may include performing color-intensity modulation (CIM) so that the light-emitting condition of the lighting is satisfied.

Thereafter, the light-emitting apparatus 100 controls the driving power of each of the plurality of light source elements based on the coded data (S440).

The color-intensity modulation (CIM) and the modulation space are described below.

Performance of visual light communication performed by the light-emitting apparatus 100 may be computed in a reception signal space. The light-receiving elements 211, 212, and 213 of the light-receiving apparatus 200 of FIG. 1 receive lighting generated by the light-emitting apparatus 100 and convert the lighting into an electrical signal. The light-receiving unit 210 receives light generated by the light-emitting unit 110. The light-receiving unit 210 may be configured to include a plurality of light-receiving elements 211, 212, and 213. The light-receiving elements 211, 212, and 213 may be photo diodes. The number, wavelength characteristic, and responsivity of the light-receiving elements 211, 212, and 213 may be different from those of the light source elements 111, 112, and 113.

If the number of light-receiving elements is n the responsivities of the respective wavelengths may be represented by r₁(λ), . . . , rₙ(λ). The responsivity is indicative of a ratio of the response of output current to the amount of light incident to the light-receiving element. In this case, the combination α₁, . . . , αₘ of the pieces of electric power of the light source in an n-dimension space may be represented as a point or a shifted subspace.

In a specific embodiment, a symbol weighted average and symbol in which communication performance is maximized in the shifted subspace are determined in the color-intensity modulation (CIM) process. In another embodiment, a symbol weighted average and symbol formed so that consumption energy is reduced in the shifted subspace, for example, so that consumption power does not exceed a threshold power value are determined in the color-intensity modulation (CIM) process.

The color-intensity modulation (CIM) is a method of coding data so that a visible ray signal generated by the light-emitting unit of the light-emitting apparatus 100 complies with the light-emitting condition. Only when a color and light intensity of lighting generated by the light-emitting apparatus 100 remain constant, a target color and target light intensity of the lighting are accurately displayed, and the target color and the target light intensity fall within a specific permissible range.

The lighting T(λ) generated by the light-emitting unit 110 may be displayed in a color space (e.g., a CIE color system (RGB, XYZ(Yxy), L*u*v*, or L*a*b*), a Munsell color system, or Ostwald) and analyzed.

Meanwhile, modulation methods using a color space are present, but modulation methods focused on minimizing an error on a color space, for example, Color Shift Keying according to the IEEE 802.15.7-2011 standard may not be easily used for the maximization of communication efficiency on a signal space for a visible ray used as lighting, the improvement of power efficiency, or the setting of lighting having a specific color and light intensity. In contrast, the light-emitting apparatus 100 according to the embodiments of this specification corresponds to a modulation method on a signal space not on a color space and may perform functions, such as the maximization of communication efficiency, the improvement of power efficiency, or the setting of lighting having a specific color and light intensity, while generating a visible ray signal that complies with a target color and target light intensity because the color-intensity modulation (CIM) is used.

That is, the color-intensity modulation (CIM) is an example of a modulation method which can satisfy conditions of a color and light intensity of lighting using a signal space, that is, a modulation space, and can maximize the capacity of visual light communication.

Furthermore, in symbol mapping in a multi-dimension channel using light source elements of different wavelengths, the color-intensity modulation (CIM) uses channels together as far as possible, compared to a case where different channels are independently used in Wavelength Division Multiplexing (WDM). Accordingly, although channels are not orthogonal to each other, signals do not interfere with each other and more efficient communication is made possible compared to a case where each of the channels is used.

More specifically, the light-emitting apparatus 100 for visual light communication according to the embodiments of this specification represents the conditions of the lighting that may be defined on a color space in the form of a target point or shifted subspace on a signal space and controls the locations and probability of symbols on a signal constellation so that the probability weighted average of the symbols on the signal constellation belongs to the target point or shifted subspace and a large amount of Mutual Information (MI) or a high data rate can be obtained.

For example, if the number of light-receiving elements of the light-receiving apparatus 200 is n, a signal received by a j^{th} light-receiving element of the light-receiving elements is expressed by Rⱼ=∫rⱼ(λ)T(λ)dλ. In this case, rⱼ(λ) is the responsivity of the j^{th} light-receiving element, and T(λ) is indicative of lighting. A reception signal Y received by the light-receiving apparatus 200 through n light-receiving elements may be represented as Y−[R₁, . . . , Rₙ]^{T}, that is, a vector form. If the light-receiving apparatus 200 receives lighting X generated by a transmitter without an influence of noise Z, the reception signal vector Y is represented in the form of Y=X+Z=X, and the reception signal Y is present in the signal space of an n dimension.

In the color-intensity modulation (CIM), a subspace in which lighting satisfies a specific light-emitting condition is indicative of a set in which a probability weighted average of X needs to be placed on a signal space. If the number of light-emitting elements is the same as the number of light-emitting conditions, the average location of symbols that satisfies the light-emitting condition corresponds to a single point in the signal space. If the number of light-emitting elements is greater than the number of light-emitting conditions, the average location of symbols that satisfies the light-emitting condition forms a subspace of one dimension or more in the signal space. For example, with respect to a light-emitting apparatus including m light-emitting elements, a probability weighted average of a light-emitting condition represented as the light intensity of the wavelengths of three RGB colors forms a subspace of one dimension if m=4, a subspace of a 2 dimension if m=5, and a subspace of a 3 dimension of m=6.

If X is orthogonal to Y, the amount of mutual information of X and Y is the same as the sum of the amount of mutual information of each dimension. That is, the amount I(X;Y) of mutual information of X and Y satisfies I(X;Y)=I(X₁;Y₁)++I(Xₘ;Yₘ). The probability and location of a symbol may be obtained by computing the symbol mapping, probability, and amount of mutual information of each axis in an orthogonal system including only AWGN.

FIG. 6 illustrates an example of symbol mapping for color-intensity modulation (CIM) in a 2-dimensional orthogonal signal space. A subspace of FIG. 6 [symbol] may be a single point indicated by a target point or may be a set including the target point. FIG. 6 illustrates a signal constellation for disposing symbols which maximizes the amount of mutual information obtained by controlling the probability and locations of the symbols depending on A/a, color and a light intensity condition that determine communication quality. In this case, ‘A’ denotes a maximum symbol intensity, and ‘σ’ denotes a standard variation of Guassian noise.

If A/σ of dimensions are 8 dB and 6 dB and the light intensities of the dimensions are 80% and 50%, the amount of mutual information is 0.9494+0.9385=1.8879 bits/symbol and the number of symbols on a constellation is 4*3=12.

FIG. 6 illustrates an example of a 2-dimensional orthogonal signal space. In a 2-dimensional non-orthogonal signal space, in general, a space in which a transmission symbol X is placed is a parallelogram not a rectangle, and the disposition of symbols is not regular as illustrated in FIG. 6. In the case of a 3-dimensional non-orthogonal signal space that is likely to be more commonly used than a 2 dimension, a space in which a transmission symbol X is placed is a parallelepiped formed of three pairs of parallel faces.

Furthermore, the color-intensity modulation (CIM) may be modified in various ways depending on the locations of symbols on the signal constellation and a method of controlling probability. Accordingly, the light-emitting apparatus 100 according to the embodiments of this specification may be modified to control the locations and probability of symbols using a Pulse Amplitude Modulation (PAM), M-ary Pulse Amplitude Modulation (M-PAM), or Pulse Width Modulation (PWM) method.

The scope of the present invention is not limited to the embodiments disclosed in this specification, and the present invention may be modified, changed, or improved in various ways without departing from the spirit of the present invention and the scope of the claims.

1. A lighting control method, comprising steps of:
obtaining a list of pieces of control information that satisfy a light-emitting condition in which lighting formed by a plurality of light source elements has a specific color or specific light intensity;
determining control information that belongs to the list and that enables a sum of pieces of driving power of the plurality of light source elements to be a specific value or less; and
controlling each of the pieces of driving power of the plurality of light source elements based on the determined control information,
wherein the control information is indicative of the driving power of each of the plurality of light source elements,
the light-emitting condition comprises a light intensity of each of a plurality of wavelengths, and
a number of the light source elements is greater than a number of the light-emitting conditions.

2. The lighting control method of claim 1, wherein in the step of obtaining the list of pieces of control information, whether the light-emitting condition is satisfied comprises determining whether the control information is control information by which the lighting complies with the light-emitting condition or whether the control information is control information by which the lighting is approximate within a permissible range of the light-emitting condition.

3. The lighting control method of claim 2, wherein the step of determining the control information comprises determining the control information that belongs to the list and by which the sum of the pieces of driving power of the plurality of light source elements is a minimum.

4. The lighting control method of claim 2, wherein:
the light-emitting condition is a light intensity of each of wavelengths corresponding to respective R, G, and B, and
the number of light source elements is 4 or more.

5. A lighting control method, comprising steps of:
obtaining a list of pieces of control information that satisfy a light-emitting condition in which lighting formed by a plurality of light source elements has a specific color or specific light intensity;
performing symbol mapping for data modulation on a signal constellation comprising control information selected from the list; and
controlling each of the pieces of driving power of the plurality of light source elements based on data modulated according to the symbol mapping,
wherein the control information is indicative of the driving power of each of the plurality of light source elements, the light-emitting condition comprises a light intensity of each of a plurality of wavelengths, a number of the light source elements is greater than a number of the light-emitting conditions, and the signal constellation is formed based on a plurality of pieces of the control information that satisfy the light-emitting condition and that are present due to a difference between the number of light source elements and the number of light-emitting conditions.

6. The lighting control method of claim 5, wherein:
the light-emitting condition is a light intensity of each of wavelengths corresponding to respective R, G, and B, and
the number of light source elements is 4 or more.

7. A lighting control method, comprising steps of:
obtaining, by a lighting apparatus configured to comprise a plurality of light source elements, a list of pieces of control information, wherein the control information is indicative of driving power of each of the plurality of light source elements;
determining control information that belongs to the list and that is most approximate to a light-emitting condition in which lighting generated by the lighting apparatus has a specific color or specific light intensity; and
controlling the driving power of each of the plurality of light source elements based on the determined control information.

8. The lighting control method of claim 7, wherein the step of determining the control information comprises determining control information by which a difference between a prediction value of a color and light intensity according to control information of the list and the light-emitting condition is a minimum.

9. A method of controlling lighting so that a lighting apparatus configured to comprise a plurality of light source elements performs visual light communication, the method comprising steps of:
obtaining a light-emitting condition indicative of a specific color and light intensity of lighting;
performing symbol mapping for data modulation so that a probability weighted average of symbols is placed in a subspace on a signal space satisfying the light-emitting condition; and
controlling driving power of each of the plurality of light source elements based on data modulated according to the symbol mapping.

10. The method of claim 9, wherein the symbol mapping is performed by taking into consideration data transfer efficiency, power efficiency, or lighting setting according to a specific light-emitting condition.

11. The method of claim 10, wherein in the step of performing the symbol mapping, locations and probability of the symbols are controlled based on the probability weighted average of the symbols on the signal space or an amount of mutual information.

12. A lighting apparatus, comprising:
a light-emitting unit which generates a visible ray signal using a plurality of light source elements generating light intensities of different wavelengths;
a control unit which obtains a list of pieces of control information satisfying a light-emitting condition of lighting and determines specific control information that belongs to the list and by which a sum of pieces of driving power of the plurality of light source elements is a specific value or less; and
a driving unit which controls the driving power of each of the light source elements based on the specific control information.

13. The lighting apparatus of claim 12, wherein:
the control unit codes data based on a symbol table having a range that satisfies the light-emitting condition on average, and
the driving unit controls the driving power so that the visible ray signal is generated based on the coded data.
